(19) United States
(12) Patent Application Publication
(10) Pub. No.: US 2023/0208913 A1
(43) Pub. Date: Jun. 29, 2023

(54) IN-ORDER STREAMING IN-NETWORK COMPUTATION

(71) Applicant: Amedeo Sapio, San Jose, CA (US)

(72) Inventor: Amedeo Sapio, San Jose, CA (US)

(21) Appl. No.: 18/116,940

(22) Filed: Mar. 3, 2023

(51) Int. Cl. H04L 67/1095; H04L 67/1097; H04L 49/9057

(52) U.S. Cl. CPC H04L 67/1095; H04L 67/1097; H04L 49/9057

(57) ABSTRACT

A device can include interfaces configured to receive data packets from compute nodes. The device can include circuitry provide data to the compute nodes to synchronize reception of data packets received from the compute nodes. The reception can be synchronized to provide data of the data packets to each memory slot of a memory in an order.

### BACKGROUND

Collective operations are common building blocks of distributed applications in networked computing environments. Collective operations can be used to synchronize or share data among multiple collaborating processes (workers) connected through a packet-switched network. The data can be split into multiple chunks, with each chunk of a size to fit in a single network packet payload. The data chunks from multiple workers can be combined and the result of the collective operation can subsequently be shared among the workers. Multipath interference and/or lack of synchronization among workers during collective operations can cause results of those operations to be erroneous.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1A illustrates an example collective operation.

FIG. 1B illustrates further details of input data aggregation for an example collective operation.

FIG. 2 illustrates in-network computation.

FIG. 3 illustrates a streaming protocol for in-network computation.

FIG. 4 illustrates hierarchical aggregation.

FIG. 5 illustrates a protocol for in-network computation according to an example embodiment.

FIG. 6 illustrates a second example of usage of a protocol for in-network computation according to an embodiment.

FIG. 7 is a block diagram of an architecture according to an example embodiment.

FIG. 8A provides an overview of example components for a compute node that can act as a worker node in example embodiments.

FIG. 8B provides a further overview of example components within a computing device that can act as a worker node in example embodiments.

FIG. 9 is a schematic diagram of an example infrastructure processing unit (IPU).

FIG. 10 depicts a flowchart of an example method for in-network computing according to an example.

### DETAILED DESCRIPTION

The following discusses approaches for providing in-order streaming in-network computation. The computations described can be part of collective operations. Collective operations can be used to synchronize and/or share data among multiple collaborating processes (workers) that are connected in some fashion, for example through a packet-switched network or in a client/server scenario. Services that make use of collective operations can include specialized and highly data parallel scientific computations such as high performance computing (HPC) services and operations.

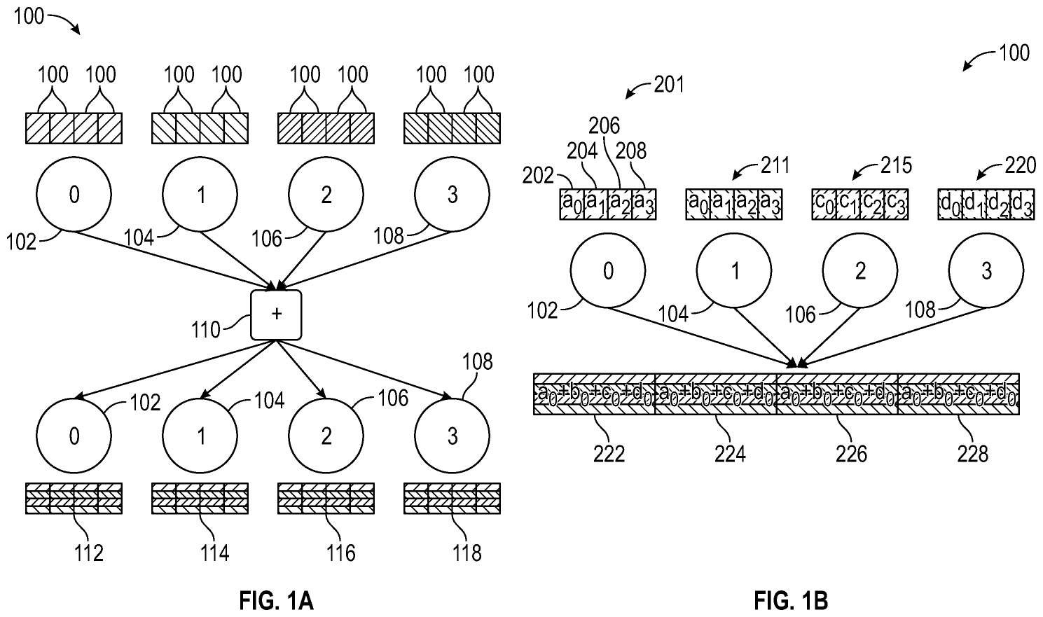

FIG. 1A illustrates a collective operation. The data can be of any size and is split in multiple chunks, 100 so that each chunk can fit in a single network packet payload. The set of workers (e.g., worker 102, worker 104, worker 106, and worker 108) that share data through collective operations are gathered in a collective group. As seen in the example collective operation of FIG. 1A, data is combined from the multiple workers 102, 104, 106, 108 at operation 110. The result is then output (e.g., “shared”) to the multiple workers 102, 104, 106, 108 such that each worker 102, 104, 106, 108 receives a full copy 112, 114, 116, 118 of the results of the operation. The operation 110 accordingly can be considered to be at least a two-operation process. For example, the input data is aggregated, and the result is distributed to all the workers 102, 104, 106, 108.

FIG. 1B illustrates further details of input data aggregation for an example collective operation. In some examples of collective operations, workers 102, 104, 106, 108 can have (or have available) a vector of numbers 202, 204, 206, 208 (integers or floating points) as input data. Numbers are shown for one worker 102 in the interest of clarity, but similar data can be seen for other workers 104, 106, 108. These vectors 201, 211, 215, 220 can be combined using a specific function or operation (e.g., an element-wise addition) that is applied separately to corresponding elements of the vector 201, 211, 215, 220. Example combined results are shown at 222, 224, 226, 228.

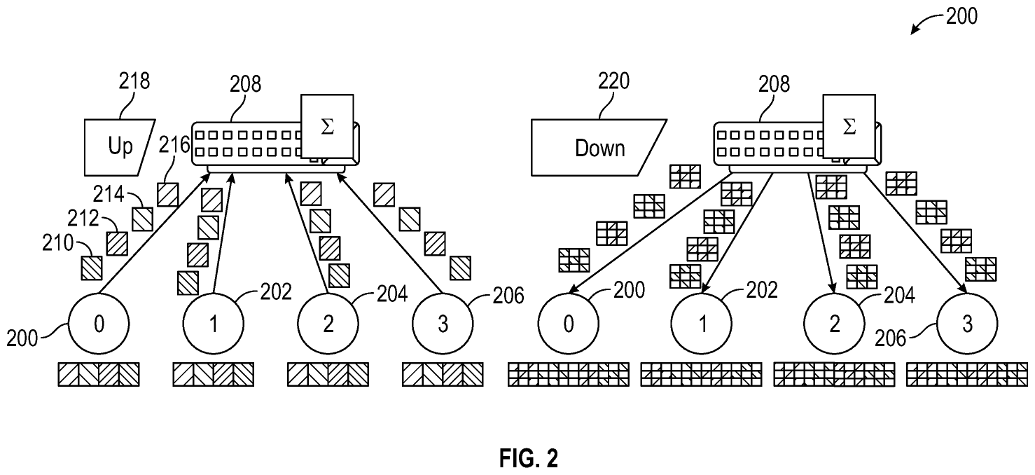

The operation or collective function can be implemented using in-network computation, wherein the data aggregation function is offloaded to network devices (e.g., switches). FIG. 2 illustrates in-network computation.

In the case of in-network computation, workers 200, 202, 204, 206 can send data to one or more switch/switches 208 using multiple packets 210, 212, 214, 216 in direction 218. The switch 208 can combine corresponding data from packets 210, 212, 214, 216 coming from different workers 200, 202, 204, 206. When one or more elements are completely aggregated, they are sent back to the workers 200, 202, 204, 206 in direction 220 using multiple copies of the same packet containing the final results.

To perform in-network computation at very high rates (e.g., in the range of multiple terabytes per second (TBps)), the switch 208 may use fast on-chip engines (e.g., arithmetic logic units (ALUs)) and memory (e.g., static random access memory (SRAM)). The amount of processing logic and memory on the chip is limited by the die area. In particular, the available on-chip memory is often smaller than the input data size. This can be the case in particular for HPC applications and machine learning (ML) applications.

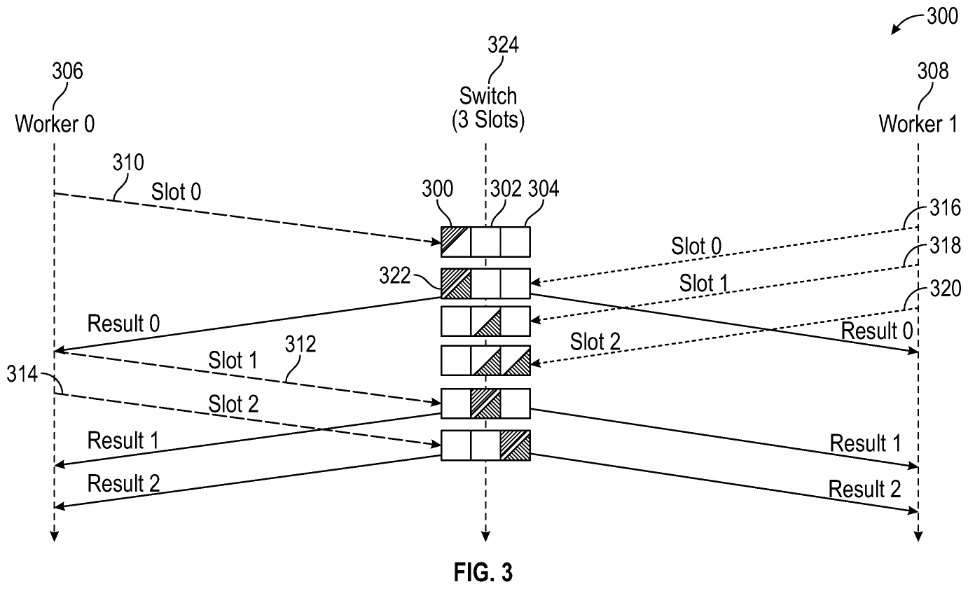

To handle such limitations, the communication for performing in-network computation can occur using a streaming protocol as shown in FIG. 3. According to this protocol, a limited amount of memory is allocated on the on-chip memory. This memory is arranged in multiple “slots” 300, 302, 304, wherein one slot can be defined as the memory used to store the maximum amount of data contained in a single packet (e.g., one maximum transmission unit (MTU)). All the allocated slots can form a “pool” illustrated in the combination of slots 300, 302, 304, for example, and similar slots as shown in FIG. 3. FIG. 3 illustrates a limited number of workers 306, 308 switch 324, etc. for purposes of clarity. It will be appreciated that in-network operations can involve hundreds or even thousands of workers, slots, switches, etc.

The participating workers 306, 308 may transmit a new packet (shown, e.g., in signals 310, 312, 314, 316, 318, 320) if there is an available slot in the pool, and the packet (transmitted in, e.g., one of in signals 310, 312, 314, 316, 318, 320) can include metadata indicating the specific slot that must be used to store the packet data. Packets from different workers 306, 308 carrying data that are to be combined together are addressed to the same slot (e.g., slot 322 shows packets from different workers combined together in slot 322). The workers 306, 308 can have access to information defining the size of the pool or other information defined through an external mechanism (e.g., a connection setup phase or configuration).

When the switch 324 receives the first packet for a certain slot (e.g., in signal 310), the switch 324 can copy the data from the packet to the memory slot. When a following packet for the same slot is received (e.g., when signal 316 provides a packet to slot 0), the switch 324 can perform a requested operation (e.g., vectorial addition) using as operands the data in the slot and the data in the packet. The result of the operation can be stored back in the same slot (e.g., slot 0 in the illustrated example). Once the switch 324 has received data for one particular slot from all the participating workers, the final result of the in-network operation is considered to be present in the slot and the switch 324 will send the result out to the workers 306, 308. Assuming that the communication medium is reliable, the slot can be freed and made available for reuse. The workers 306, 308 that receive the result for one slot can continue operations under the assumption that the freed slot is now available, and the workers 306, 308 can send new data addressed to the same slot.

The protocol described with reference to FIG. 3 can help improve usage of scarce on-chip memory to perform collective operations with data of any size, and at full line rate bandwidth, as long as the pool is large enough to cover the bandwidth-delay product (BDP). The protocol described with reference to FIG. 3 is generally sufficient if there is no requirement about the order of the operations. Because workers 306, 308 send the data for a certain slot without synchronizing (which would require at least one additional round trip time (RTT) to the latency for each slot, which is unacceptable in typical applications, including HPC), the order of arrival of packets for a certain slot from multiple workers is unpredictable. For example, for a slot 0 and 4 workers (a, b, c, d) the final result can be ((a₀+b₀)+c₀)+d₀ or it can be ((c₀+d₀)+b₀)+a₀. While the order of operations does not matter if the function is commutative and associative (as is the case with, for example, an integer sum), it does matter for the functions that are not commutative and associative. One very common such case (e.g., in HPC and ML applications) is when the operands are floating point numbers. While the algebraic sum and multiplication are commutative and associative when considering real numbers, these functions are not commutative and associative when considering a floating point representation with a fixed bit size, because of the rounding errors that can compound differently depending on the order of the operations. For this reason, with floating point numbers ((a₀+b₀)+c₀)+d₀≠((c₀+d₀)+b₀)+a₀.

For at least this reason, the streaming aggregation protocol described above has the limitation that it does not guarantee the order of the operations, so it may happen that the same inputs provide a different result just because packets have been received in a different order by the switch. This is a problem when there is the need to have reproducible results, e.g., where different executions using the same input data must provide the exact same result.

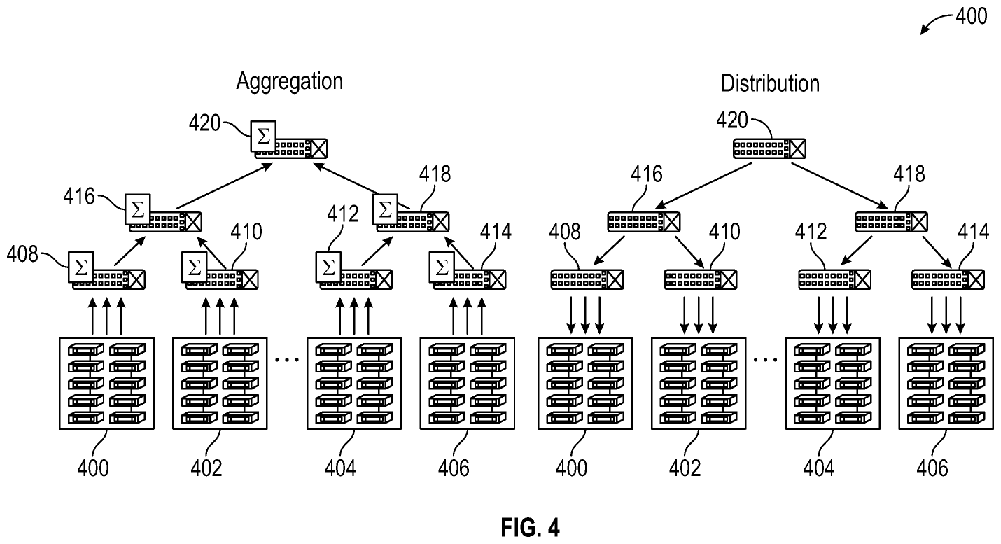

While this streaming aggregation protocol has been described in a single switch scenario, the streaming aggregation protocol is applicable to a multi-switch scenario, through hierarchical aggregation as shown in FIG. 4. As seen in FIG. 4, workers or groups of workers 400, 402, 404, 406 can send and receive data to and from the directly attached switch 408, 410, 412, 414, which is in charge of aggregating the data from respective workers or groups of workers. This switch 408, 410, 412, 414 can send the result to the next level switch. Higher level switches 416, 418 aggregate the data from lower level switches 408, 410, 412, 414. Additional higher level switch 420 can be included, and any number of hierarchies or tiers thereof can be included. Once the top level switch 420 has received all the contributions and has the final results, the top level switch 420 can send the packet(s) with the result to the lower level switches 416, 418 that can replicate the results to switches 408, 410, 312, 414 for provisioning to workers 400, 402, 404, 406. Further description below will be provided for single-switch networks but can be applied to hierarchical use cases as well.

The above described in-network computations and similar applications have extensive use of switch memory. This is because existing solutions that are able to guarantee the correct order of the operations require that the data from multiple workers are buffered in the switch, instead of being immediately processed. In the worst case, data is combined only when the data from all workers have been received, so that data can be processed in the right order, instead of the order of arrival. This requires that the memory used is proportional to the number of workers. If N_{S} is the number of slots needed to cover the BDP (in the sense that there are no occasions in which the worker cannot send data because all of the slots are used), the number of slots required to support in-order operations is N×N_{S}, so this limits the scalability of the solution. Furthermore, multipath interference can cause out-of-order packets, which can lead to erroneous results for operations that are not commutative (e.g., floating point arithmetic). Finally, the above-described approaches can have a larger tail latency, because instead of doing one aggregation per packet consistently, these solutions require that, in some cases, all N operations are performed when the last packet arrives.

These and other issues are addressed using device processing, systems and methods according to example embodiments. Solutions described herein can guarantee in-order in-network aggregation by providing commands to instruct workers to send contributions to a slot in a consistent order with no additional synchronization. In examples, a worker (e.g., compute node, client, etc.) is always one slot ahead of the following worker. For example, while worker 0 is sending data to slot N−1, worker 1 sends data to slot N−2, and so on, until worker N−1, which sends data to slot 0.

Collective functions can also be implemented in a client-server configuration. When implemented using a client-server concept, the server can perform computation on data from the other workers (e.g., clients) and transmit the result back to all the workers. The server in such a configuration or implementation can also be referred to as a “parameter server.” While client-server implementations are not constricted (typically) by memory or processing power in a manner similar to switching and worker node systems, client-server embodiments can provide benefits to client-server systems as well.

Embodiments described herein provide a reproducible streaming in-network aggregation. Systems according to embodiments make use of a reliable transport protocol for sending and receiving packets between worker nodes and switches (or between clients and a server in client-server embodiments). The transport protocol used can guarantee in-order packet delivery.

A number of memory slots N_{S} can be allocated to perform collective operations. For example, N_{S} needs to be equal to or greater than the number of workers or ports connected to each switch. In examples, the number of workers or ports connected to each switch will be less than 512. Given a slot size (MTU) on the order of 10 kilobytes (KB) or less, an example memory size for slot memory on a switch will be less than 5 megabytes (MB), or well within a memory range available on many switching chips.

Devices, such as system-on-a-chip (SOC) devices, network devices, or servers in a client-server configuration) receive data packets for a certain memory slot in a consistently same order without use of additional synchronization messages after a bootstrap or configuration stage. To achieve this, protocols and methods according to embodiments can mandate or force one worker (e.g., port-connected node, compute node, client, etc.) to always be ahead of a next worker by one slot with regard to transmission of corresponding packets. For example, given N slots, the protocol forces one worker to always be one slot ahead of the following worker as illustrated: Worker 0 is N−1 slots ahead, Worker 1 is N−2 slots ahead, Worker N−2 is 1 slot ahead, and Worker N−1 is consistently the last worker to send data (e.g., a packet) to any given slot.

In this way, one slot is always updated first by worker 0, then by worker 1, and so on, until worker N−1 is the last to provide a packet to a slot. Because packets are provided in order, computation reproducibility is guaranteed and non-commutative operations are correctly or consistently calculated. Systems and methods according to embodiments are self-clocking, because when a slot is complete (e.g., when a slot includes packets from each worker, client, etc. attached to the switch or server), the result is sent to all workers at the same time, and the workers use this packet as a signal to move forward to send data to the next slot, using different slots as described above.

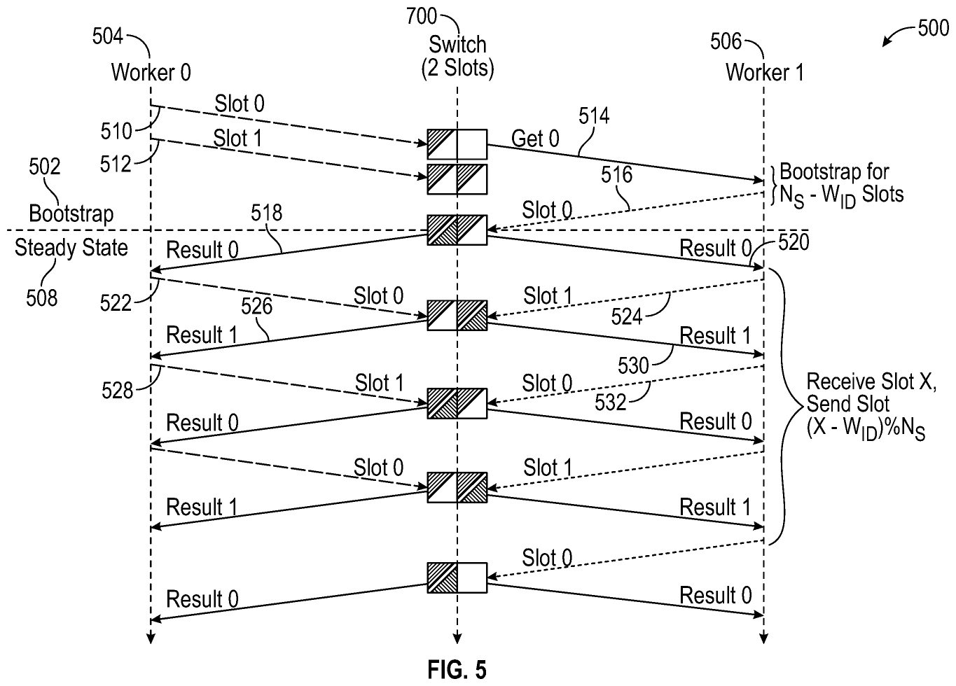

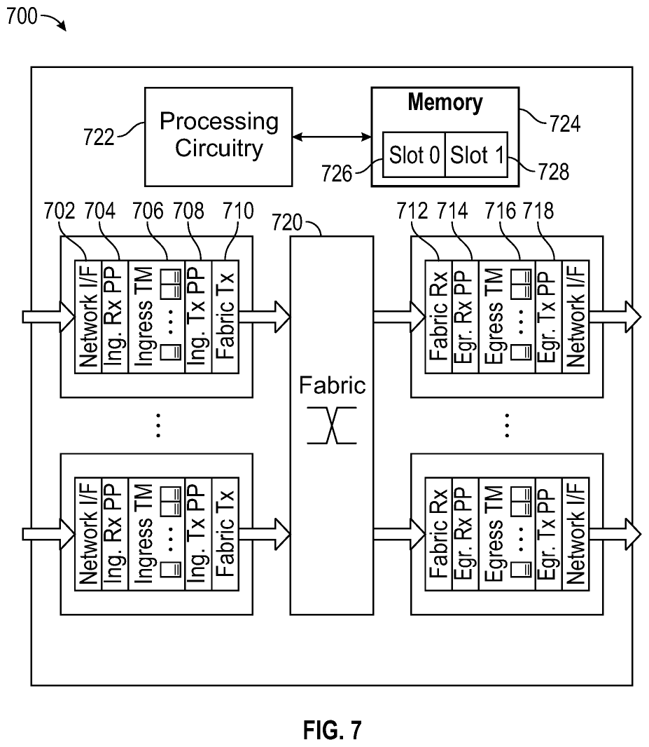

FIG. 5 illustrates an example protocol 500 for in-network computation according to an example embodiment. Device 700 illustrated in FIG. 5 can include components of FIG. 7, and accordingly discussion of FIG. 5 is made with reference to components of device 700 (FIG. 7). FIG. 5 illustrates two worker nodes 504, 506 for purposes of clarity. However, embodiments are not limited thereto. Rather, protocols in accordance with embodiments can include several worker nodes, and several switches, and switches can be arranged in a hierarchical order as described above with reference to FIG. 4.

Referring still to FIG. 5, protocol 500 is divided into two phases. First, a bootstrap phase 502 includes a bootstrap process (also referred to as synchronization in some embodiments) for worker nodes 504, 506 to start the self-clocking mechanism and arrive at a steady state 508 in which each worker node 504, 506 is one slot ahead of another. In the example, worker node 504 is one slot ahead of worker node 506, as will be further described below. In the steady state 508, each worker 504, 506 can transmit one packet to the device 700 for each received packet from the device 700.

The bootstrap phase 502 makes use of a small number of synchronization signals, with the number depending on the number of workers (or clients, etc.) that are configured to be connected to the corresponding switch (or server). The synchronization signals will not have a large impact on overhead because solutions according to embodiments are targeted toward use cases having a large number of packets per collective operation, with the number of packets being substantially larger than the number of workers for which synchronization signals are used.

In the bootstrap phase 502, as implemented by circuitry 702 (FIG. 7) of the device 700 or other component of the device 700, worker node 504 can transmit N_{S} packets in signals 510, 512 to use all the available slots (e.g., two slots in the illustration, and as described with respect to slots 726, 728 (FIG. 7).

Responsive to receiving a first data packet from worker node 504 (e.g., a “first” compute node) circuitry 702 can store the data packet in a first slot. The circuitry 702 can store the data packet received at signal 512 into the second slot. The circuitry can transmit a pull command 514 to worker node 506 (e.g., “second” compute node) or other multiple worker nodes (not shown in FIG. 5). The pull command 514 can cause the worker node 506 to provide a data packet (provided in signal 516) for storing in the first slot.

Extended to typical usage scenarios with multiple worker nodes, this pull command 514 can be provided to additional worker nodes requesting slot X from worker 1 (where worker IDs start from worker 0, e.g., worker 1 is the second worker in the sequence of workers), slot X−1 from worker 2, and so on, until it sends a request for slot X−(N−2) to worker N−1. When a worker receives a “pull” request for a slot, the worker transmits a new packet addressed to that slot. When the device 700 has a completed slot (e.g., when a data packet is received from each worker for that corresponding slot), the device 700 can send the result contained in that slot to all the workers and mark that slot as available for reuse.

At the end of the bootstrap phase 502, each worker is one slot ahead of the following worker, which is the condition that must be kept throughout the steady state 508 condition. The circuitry 702 can maintain this steady-state 508 protocol and maintain an in-order condition without sending any other synchronizing messages.

In the steady-state phase 508, each worker 504, 506 can transmit one packet with new data for every received packet containing results. For example, when a result is provided at signal 518 to worker 504, worker 504 transmits another packet at signal 522. When a result is provided at signal 520 to worker 506, worker 506 transmits another packet at signal 524. A wait period or delay is not provided before transmitting the packet at signal 524 (nor in similar signals shown in FIG. 5). Generalized to multiple workers, a worker with rank Wu) that receives a packet with the result for slot S, can transmit a new packet addressed to slot (S−W_{ID}) % N_{S} (where “%” is the modulo operator). For example, when worker 504 (having rank W_{ID}=0) receives a packet with the result for slot 1 (seen at signal 526), worker 504 transmits a new packet addressed to slot 1 (seen at signal 528). When worker 506 (having W_{ID}=1) receives a packet with the result for slot 1 (seen at signal 530), worker 506 transmits a new packet addressed to slot 0 (1'1=0) as seen at signal 532.

Failure protection logic, which is outside the scope of the present disclosure can provide a timeout to identify that recovery may be required. Failures can include link failures, device (e.g., network device or switch) failure, worker node failure, etc. Packets may be dropped due to network congestion or data corruption, generating a need for timeouts and retransmissions. Solutions can be available based on the assumed reliable transport that is provided in systems according to embodiments, as described earlier herein.

This protocol as shown by the example of FIG. 5 can guarantee that worker 504 is always the first to update a slot, and worker N−1 is always last, so the order of the operation is always the same. The steady-state phase continues until all workers have no more data to send and have received all the results. At this point the operation is complete and the device 700 memory can be reallocated to a new operation.

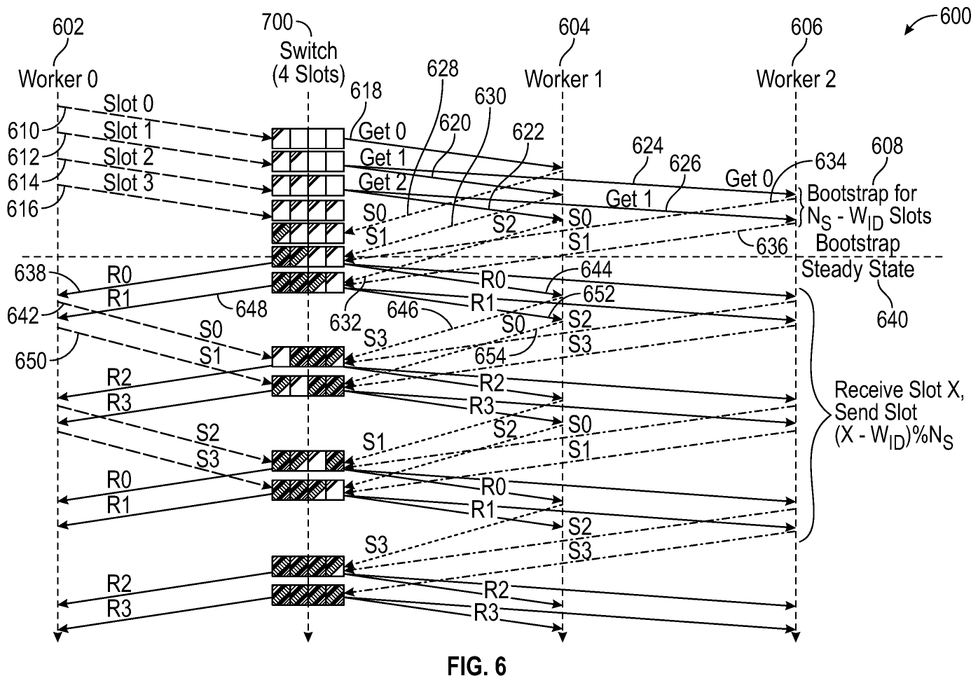

FIG. 6 illustrates a second example of usage 600 of a protocol for in-network computation according to an embodiment. In the example, three worker nodes 602, 604, and 606 are shown. Worker 602 has WID=0. In bootstrap phase 608, worker 602 provides data packets for each slot using signals 610 612, 614, and 616. In response to signals 610,612, 614 and 616, the device 700 generates pull commands to worker 604 for N_{S}−W_{ID} (4−1=3) slots using pull commands 618, 620 and 622. In response, worker 604 provides packets for three slots in signals 628, 630 and 632. The device 700 generates pull commands to worker 606 for N_{S}−W_{ID} (4−2=2) slots using pull commands 624 and 626. In response, worker 606 provides packets for two slots in signals 634 and 636.

As each slot is filled with a data packet from each worker 602, 604, 606, the device 700 provides results (e.g., of the collective operation or other in-network computation) to each worker 602, 604, 606. For example, when slot 0 includes data from each worker 602, 604, 606 result signal 638 is provided.

In the steady-state phase 640, each worker 602, 604, 606 can transmit one packet with new data for every received packet containing results. For example, when a result is provided at signal 638 to worker 602, worker 602 transmits another packet at signal 642. When a result is provided at signal 644 to worker 604, worker 604 transmits another packet at signal 646. Generalized to multiple workers, a worker with rank W_{ID} that receives a packet with the result for slot S, can transmit a new packet addressed to slot (S−W_{ID}) % NS (where “%” is the modulo operator). For example, when worker 602 (having rank W_{ID} =0) receives a packet with the result for slot 1 (seen at signal 648), worker 602 transmits a new packet addressed to slot 1 (seen at signal 650). When worker 604 (having W_{ID}=1) receives a packet with the result for slot 1 (seen at signal 652), worker 604 transmits a new packet addressed to slot 0 (1−1=0) as seen at signal 654

FIG. 7 is a block diagram a device 700 according to an example embodiment. The device 700 can perform functions of methodologies described with respect to FIG. 5 and FIG. 6 above. The device 700 can include a network interface (NIF) 702 for receiving packets from a number of compute node/s or worker node/s and for providing results of collective operations. Various similar blocks can be provided in multiple chains as shown in FIG. 7.

Receive packets can be processed by circuitry 704, where packet headers can be processed and enqueue requests can be provided to traffic management circuitry 706. Circuitry 704 can also edit incoming packets to facilitate packet handling by subsequent circuitry in a chain. Queues can include traffic management queues for providing output and for multicasting.

Received packets can be transmitted at transmission circuitry 708 and provided to fabric 720 using circuitry 710. Packets arriving from the fabric 720 at circuitry 712 can be mapped to egress traffic management queues at circuitry 714. The circuitry 712 can provide one or more enqueue requests per packet, to the egress traffic management circuitry 716. Egress traffic management circuitry 716 can maintain queues for unicast and multicast traffic. Circuitry 718 can edit outgoing packets according to packet headers.

The device 700 can include processing circuitry 722 coupled to one or more of the interfaces 702. The processing circuitry 722 can configure a memory 724 of the hardware switch into a logical plurality of slots 726, 728 for storing the data packets according to methods and protocols described above with reference to FIG. 5 and FIG. 6. While two slots 726, 728 are shown, any number of slots can be provided as long as the number of slots is at least equal to the number of worker nodes/clients.

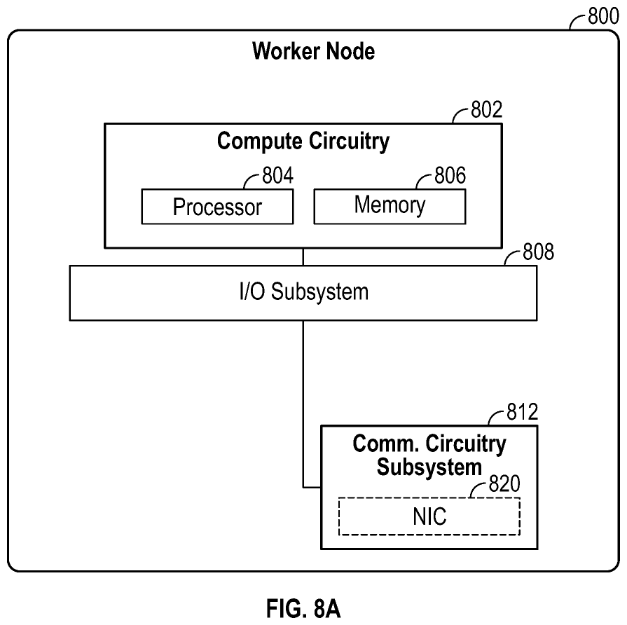

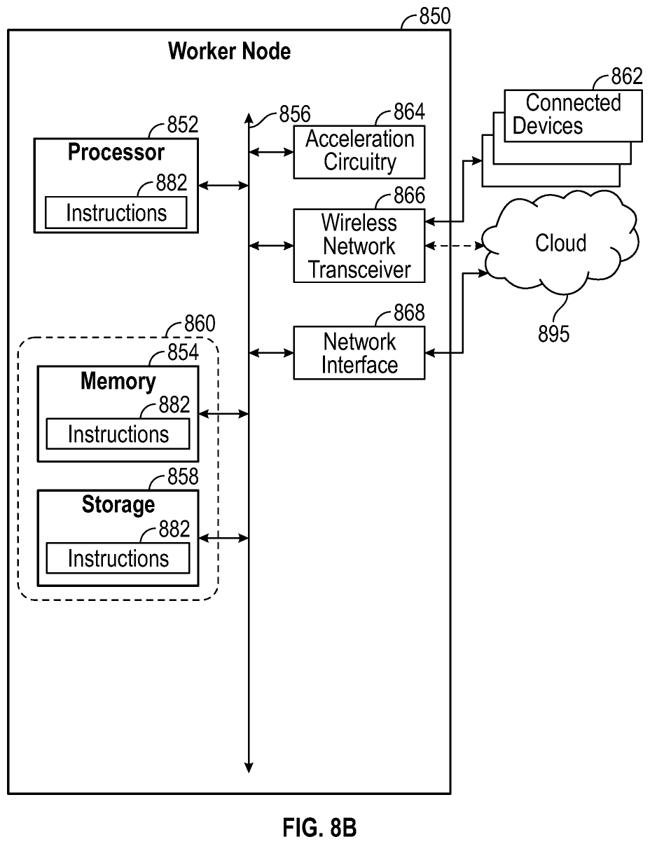

The embodiments described with respect to FIG. 1A-FIG. 7 can be implemented in a variety of systems. For example, worker nodes or client nodes can be implemented according to FIG. 8A and FIG. 8B. Worker nodes may be embodied as a type of device, appliance, computer, or other “thing” capable of communicating with other computing, networking, or endpoint components. For example, a worker node device may be embodied as a personal computer, server, smartphone, a mobile compute device, a smart appliance, an in-vehicle compute system (e.g., a navigation system), a self-contained device having an outer case, shell, etc., or other device or system capable of performing the described functions.

In the simplified example depicted in FIG. 8A, worker node 800 includes a compute engine (also referred to herein as “compute circuitry”) 802, an input/output (I/O) subsystem (also referred to herein as “I/O circuitry”) 808, data storage (also referred to herein as “data storage circuitry”) 810, a communication circuitry subsystem 812, and, optionally, one or more peripheral devices (also referred to herein as “peripheral device circuitry”) 814. In other examples, respective compute devices may include other or additional components, such as those typically found in a computer (e.g., a display, peripheral devices, etc.). Additionally, in some examples, one or more of the illustrative components may be incorporated in, or otherwise form a portion of, another component.

The worker node 800 may be embodied as any type of engine, device, or collection of devices capable of performing various compute functions. In some examples, the worker node 800 may be embodied as a single device such as an integrated circuit, an embedded system, a field-programmable gate array (FPGA), a system-on-a-chip (SOC), or other integrated system or device. In the illustrative example, the worker node 800 includes or is embodied as a processor (also referred to herein as “processor circuitry”) 804 and a memory (also referred to herein as “memory circuitry”) 806. The processor 804 may be embodied as any type of processor(s) capable of performing the functions described herein (e.g., executing an application). For example, the processor 804 may be embodied as a multi-core processor(s), a microcontroller, a processing unit, a specialized or special purpose processing unit, or other processor or processing/controlling circuit.

In some examples, the processor 804 may be embodied as, include, or be coupled to an FPGA, an application specific integrated circuit (ASIC), reconfigurable hardware or hardware circuitry, or other specialized hardware to facilitate performance of the functions described herein. Also in some examples, the processor 804 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), acceleration circuitry, storage devices, storage disks, or AI hardware (e.g., GPUs, programmed FPGAs, or ASICs tailored to implement an AI model such as a neural network). Such an xPU may be designed to receive, retrieve, and/or otherwise obtain programming to process one or more data streams and perform specific tasks and actions for the data streams (such as hosting microservices, performing service management or orchestration, organizing or managing server or data center hardware, managing service meshes, or collecting and distributing telemetry), outside of the CPU or general purpose processing hardware. However, it will be understood that an xPU, an SOC, a CPU, and other variations of the processor D104 may work in coordination with each other to execute many types of operations and instructions within and on behalf of the compute node D100. The memory 806 may be embodied as any type of volatile (e.g., dynamic random access memory (DRAM), etc.) or non-volatile memory or data storage capable of performing the functions described herein.

The compute circuitry 802 is communicatively coupled to other components of the worker node 800 via the I/O subsystem 808, which may be embodied as circuitry and/or components to facilitate input/output operations with the compute circuitry 802 (e.g., with the processor 804 and/or the main memory 806) and other components of the compute circuitry 802. The communication circuitry 812 may be embodied as any communication circuit, device, or collection thereof, capable of enabling communications over a network between the compute circuitry 802 and another compute device.

The illustrative communication circuitry 812 includes a network interface controller (NIC) 820, which may also be referred to as a host fabric interface (HFI). The NIC 820 may be embodied as one or more add-in-boards, daughter cards, network interface cards, controller chips, chipsets, or other devices that may be used by the worker node 800 to connect with another compute device.

In a more detailed example, FIG. 8B illustrates a block diagram of an example of components that may be present in a worker node 850 for implementing the techniques (e.g., operations, processes, methods, and methodologies) described herein. This worker node 850 provides a closer view of the respective components of node D100 when implemented as or as part of a computing device (e.g., as a mobile device, a base station, server, gateway, etc.). The worker node 850 may include any combination of the hardware or logical components referenced herein, and it may include or couple with any device. The components may be implemented as integrated circuits (ICs), portions thereof, discrete electronic devices, or other modules, instruction sets, programmable logic or algorithms, hardware, hardware accelerators, software, firmware, or a combination thereof adapted in the worker node 850, or as components otherwise incorporated within a chassis of a larger system.

The worker node 850 may include processing circuitry in the form of a processor 852, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 852 may be a part of a system on a chip (SoC) in which the processor 852 and other components are formed into a single integrated circuit, or a single package, such as the Edison™ or Galileo™ SoC boards from Intel Corporation, Santa Clara, Calif.

The processor 852 may communicate with a system memory 854 over an interconnect 856 (e.g., a bus). Any number of memory devices may be used to provide for a given amount of system memory.

To provide for persistent storage of information such as data, applications, operating systems and so forth, a storage 858 may also couple to the processor 852 via the interconnect 856. The components may communicate over the interconnect 856. The interconnect 856 may include any number of technologies, including industry standard architecture (ISA), extended ISA (EISA), peripheral component interconnect (PCI), peripheral component interconnect extended (PCIx), PCI express (PCIe), or any number of other technologies. The interconnect 856 may be a proprietary bus, for example, used in an SoC based system. Other bus systems may be included, such as an Inter-Integrated Circuit (I2C) interface, a Serial Peripheral Interface (SPI) interface, point to point interfaces, and a power bus, among others.

The interconnect 856 may couple the processor 852 to a transceiver 866, for communications with the other devices 862. A wireless network transceiver 866 (e.g., a radio transceiver) may be included to communicate with devices or services in a cloud 895 via local or wide area network protocols.

Given the variety of types of applicable communications from the device to another component or network, applicable communications circuitry used by the device may include or be embodied by any one or more of components 864, D166, 868, or 870. Accordingly, in various examples, applicable means for communicating (e.g., receiving, transmitting, etc.) may be embodied by such communications circuitry.

The worker node 850 may include or be coupled to acceleration circuitry 864, which may be embodied by one or more artificial intelligence (AI) accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. These tasks also may include the specific tasks for in-network computation discussed elsewhere in this document.

The storage 858 may include instructions 882 in the form of software, firmware, or hardware commands to implement the techniques described herein. Although such instructions 882 are shown as code blocks included in the memory 854 and the storage 858, it may be understood that any of the code blocks may be replaced with hardwired circuits, for example, built into an application specific integrated circuit (ASIC).

In an example, the instructions 882 provided via the memory 854, the storage 858, or the processor 852 may be embodied as a non-transitory, machine-readable medium 860 including code to direct the processor 852 to perform electronic operations in the worker node 850. The processor 852 may access the non-transitory, machine-readable medium 860 over the interconnect D156. The non-transitory, machine-readable medium 860 may include instructions to direct the processor 852 to perform a specific sequence or flow of actions, for example, as described with respect to the flowchart(s) and block diagram(s) of operations and functionality depicted above. As used herein, the terms “machine-readable medium” and “computer-readable medium” are interchangeable. As used herein, the term “non-transitory computer-readable medium” is expressly defined to include any type of computer readable storage device and/or storage disk and to exclude propagating signals and to exclude transmission media.

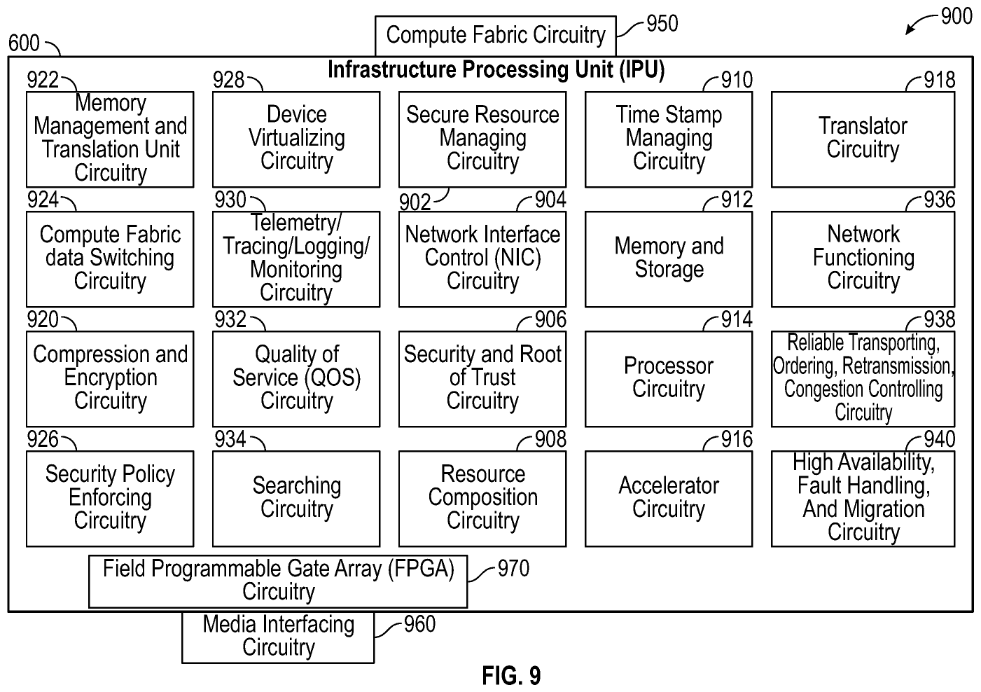

FIG. 9 depicts an example of an infrastructure processing unit (IPU). Different examples of IPUs disclosed herein enable improved performance, management, security and coordination functions between entities (e.g., cloud service providers), and enable infrastructure offload and/or communications coordination functions. As disclosed in further detail below, IPUs may be integrated with smart NICs and storage or memory (e.g., on a same die, system on chip (SoC), or connected dies) that are located at on-premises systems, base stations, gateways, neighborhood central offices, and so forth. Different examples of one or more IPUs disclosed herein can perform an application including any number of microservices, where each microservice runs in its own process and communicates using protocols (e.g., an HTTP resource API, message service or gRPC). Microservices can be independently deployed using centralized management of these services. A management system may be written in different programming languages and use different data storage technologies.

Furthermore, one or more IPUs can execute platform management, networking stack processing operations, security (crypto) operations, storage software, identity and key management, telemetry, logging, monitoring and service mesh (e.g., control how different microservices communicate with one another). The IPU can access an xPU to offload performance of various tasks. For instance, an IPU exposes XPU, storage, memory, and CPU resources and capabilities as a service that can be accessed by other microservices for function composition. This can improve performance and reduce data movement and latency. An IPU can perform capabilities such as those of a router, load balancer, firewall, TCP/reliable transport, a service mesh (e.g., proxy or API gateway), security, data-transformation, authentication, quality of service (QoS), security, telemetry measurement, event logging, initiating and managing data flows, data placement, or job scheduling of resources on an xPU, storage, memory, or CPU.

In the illustrated example of FIG. 9, the IPU 900 includes or otherwise accesses secure resource managing circuitry 902, network interface controller (NIC) circuitry 904, security and root of trust circuitry 906 , resource composition circuitry 908, time stamp managing circuitry 910, memory and storage 912, processing circuitry 914, accelerator circuitry 916, and/or translator circuitry 918. Any number and/or combination of other structure(s) can be used such as but not limited to compression and encryption circuitry 920, memory management and translation unit circuitry 922, compute fabric data switching circuitry 924, security policy enforcing circuitry 926, device virtualizing circuitry 928, telemetry, tracing, logging and monitoring circuitry 930, quality of service circuitry 932, searching circuitry 934, network functioning circuitry (e.g., routing, firewall, load balancing, network address translating (NAT), etc.) 936, reliable transporting, ordering, retransmission, congestion controlling circuitry 938, and high availability, fault handling and migration circuitry 940 shown in FIG. 9. Different examples can use one or more structures (components) of the example IPU 900 together or separately. For example, compression and encryption circuitry 920 can be used as a separate service or chained as part of a data flow with vSwitch and packet encryption.

In some examples, IPU 900 includes a field programmable gate array (FPGA) 970 structured to receive commands from an CPU, XPU, or application via an API and perform commands/tasks on behalf of the CPU, including workload management and offload or accelerator operations. The illustrated example of FIG. 9 may include any number of FPGAs configured and/or otherwise structured to perform any operations of any IPU described herein.

Example compute fabric circuitry 950 provides connectivity to a local host or device (e.g., server or device (e.g., xPU, memory, or storage device)). Connectivity with a local host or device or smartNIC or another IPU is, in some examples, provided using one or more of peripheral component interconnect express (PCIe), ARM AXI, Intel® QuickPath Interconnect (QPI), Intel® Ultra Path Interconnect (UPI), Intel® On-Chip System Fabric (IOSF), Omnipath, Ethernet, Compute Express Link (CXL), HyperTransport, NVLink, Advanced Microcontroller Bus Architecture (AMBA) interconnect, OpenCAPI, Gen-Z, CCIX, Infinity Fabric (IF), and so forth. Different examples of the host connectivity provide symmetric memory and caching to enable equal peering between CPU, XPU, and IPU (e.g., via CXL.cache and CXL.mem).

Example media interfacing circuitry 960 provides connectivity to a remote smartNIC or another IPU or service via a network medium or fabric. This can be provided over any type of network media (e.g., wired or wireless) and using any protocol (e.g., Ethernet, InfiniBand, Fiber channel, ATM, to name a few).

In some examples, instead of the server/CPU being the primary component managing IPU 900, IPU 900 is a root of a system (e.g., rack of servers or data center) and manages compute resources (e.g., CPU, xPU, storage, memory, other IPUs, and so forth) in the IPU 900 and outside of the IPU 900. Different operations of an IPU are described below.

In some examples, the IPU 900 performs orchestration to decide which hardware or software is to execute a workload based on available resources (e.g., services and devices) and considers service level agreements and latencies, to determine whether resources (e.g., CPU, xPU, storage, memory, etc.) are to be allocated from the local host or from a remote host or pooled resource. In examples when the IPU 900 is selected to perform a workload, secure resource managing circuitry 902 offloads work to a CPU, xPU, or other device and the IPU D200 accelerates connectivity of distributed runtimes, reduce latency, CPU and increases reliability.

In some examples, secure resource managing circuitry 902 runs a service mesh to decide what resource is to execute workload, and provide for L7 (application layer) and remote procedure call (RPC) traffic to bypass kernel altogether so that a user space application can communicate directly with the example IPU 900 (e.g., IPU 900 and application can share a memory space). In some examples, a service mesh is a configurable, low-latency infrastructure layer designed to handle communication among application microservices using application programming interfaces (APIs) (e.g., over remote procedure calls (RPCs)). The example service mesh provides fast, reliable, and secure communication among containerized or virtualized application infrastructure services. The service mesh can provide critical capabilities including, but not limited to service discovery, load balancing, encryption, observability, traceability, authentication and authorization, and support for the circuit breaker pattern.

In some examples, infrastructure services include a composite node created by an IPU at or after a workload from an application is received. In some cases, the composite node includes access to hardware devices, software using APIs, RPCs, gRPCs, or communications protocols with instructions such as, but not limited, to iSCSI, NVMe-oF, or CXL.

In some cases, the example IPU 900 dynamically selects itself to run a given workload (e.g., microservice) within a composable infrastructure including an IPU, xPU, CPU, storage, memory, and other devices in a node.

In some examples, communications transit through media interfacing circuitry 960 of the example IPU 900 through a NIC/smartNIC (for cross node communications) or loopback back to a local service on the same host. Communications through the example media interfacing circuitry 960 of the example IPU 900 to another IPU can then use shared memory support transport between xPUs switched through the local IPUs. Use of IPU-to-IPU communication can reduce latency and jitter through ingress scheduling of messages and work processing based on service level objective (SLO).

For example, for a request to a database application that requires a response, the example IPU 900 prioritizes its processing to minimize the stalling of the requesting application. In some examples, the IPU 900 schedules the prioritized message request issuing the event to execute a SQL query database and the example IPU constructs microservices that issue SQL queries and the queries are sent to the appropriate devices or services.

Embodiments described herein can be used to implement line-rate in-order in-network aggregation on switching chips with very limited overhead in terms of chip hardware. For example, additional ALUs are not needed, and only a limited number of additional memory slots are needed. Having the ability to perform reproducible in-network aggregation increases the value of an in-network compute solution, given that reproducibility is increasingly an important requirement of distributed applications.

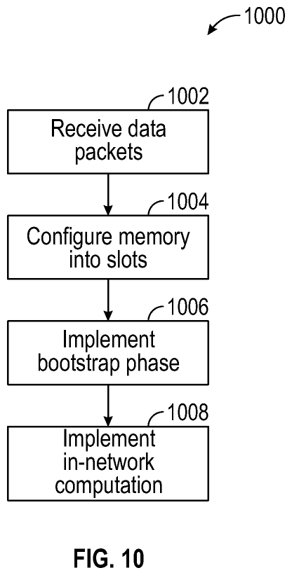

FIG. 10 depicts a flowchart of an example method 1000 for in-network computing. The method 1000 may be implemented by one or more hardware switches described with reference to FIG. 7, for operating with networked devices such as work nodes described with reference to FIG. 8A and 8B using any of the protocols described herein.

At 1002, a switch (such as FIG. 7 device 700) or server or other central network-side device can receive data packets from a plurality of compute nodes.

At 1004, processing circuitry (e.g., processing circuitry of the device 700, server, etc.) can configure a memory unit into a logical plurality of slots for storing the data packets.

At 1006, the processing circuitry can implement a bootstrap phase as described above with reference to FIG. 5 and FIG. 6. For example, responsive to receiving a first data packet from a first compute node of the plurality of compute nodes, processing circuitry can store the data packet in a first slot of the plurality of slots and transmit a pull command to a second compute node of the plurality of compute nodes to pull a data packet for storing in the first slot. Further within the bootstrap phase, the processing circuitry can receive a second data packet from the first compute node and storing the second data packet in a second slot of the plurality of slots. The processing circuitry can store the data packet from the second compute node in the first slot after having processed the data packet and combined it with the data in the slot, subsequent to or concurrently with storing the second data packet from the first compute node in the second slot.

At 1008, after the bootstrap phase described in operation 1006, a steady state phase can occur in which in-network computation occurs based on data packets received from the plurality of compute nodes in an order provided during the bootstrap phase.

### Use Cases and Additional Examples

Additional examples of the presently described method, system, and device embodiments include the following, non-limiting implementations. Each of the following non-limiting examples may stand on its own or may be combined in any permutation or combination with any one or more of the other examples provided below or throughout the present disclosure.

Example 1 is a device comprising: interfaces configured to receive data packets from a plurality of compute nodes; and circuitry coupled to the interfaces, the circuitry to: provide data to the plurality of compute nodes to synchronize reception of data packets received from the plurality of compute nodes, wherein the reception is synchronized to provide data of the data packets to each memory slot of a memory in an order.

In Example 2, the subject matter of Example 1 can optionally include wherein to synchronize data packet reception, the circuitry is configured to: responsive to reception of a first data packet from a first compute node of the plurality of compute nodes, store the data of the first data packet in a first slot of the plurality of slots and transmit a pull command to a second compute node of the plurality of compute nodes to pull a data packet for storing in the first slot; and store data of a second data packet from the first compute node in a second slot of the plurality of slots.

In Example 3, the subject matter of Example 2 can optionally include wherein the synchronizing further include operations to store the data from the second compute node in the first slot, subsequent to or concurrently an operation to store the second data from the first compute node in the second slot; and subsequent to the synchronizing, the circuitry is configured to perform in-network computation based on data packets received from the plurality of compute nodes in an order provided during the synchronizing.

In Example 4, the subject matter of Example 3 can optionally include wherein to store the data from the second compute node in the first slot the circuitry is configured to combine the data from the second compute node with data of the first data packet from the first compute node into a single packet.

In Example 5, the subject matter of Example 4 can optionally include wherein the circuitry is configured to, upon detecting that data from each compute node has been stored into a slot, provide data packets stored in the respective slot to each of the compute nodes.

In Example 6, the subject matter of Example 5 can optionally include wherein the circuitry is configured to transmit pull commands, separately and iteratively, to additional compute nodes of the plurality of compute nodes, such that data received from the additional compute nodes are stored and combined with other data in sequential order in the first slot of the plurality of slots.

In Example 7 the subject matter of any of Examples 1-6 can optionally include wherein the number of slots is at least the number of the plurality of computing nodes.

In Example 8, the subject matter of any of Examples 1-7 can optionally include wherein a count of the plurality of slots is based on a configuration parameter provided to the device.

In Example 9, the subject matter of any of Examples 1-8 can optionally include wherein an order for storing data packets of the plurality of slots is determined based upon configuration information received during a communication initialization process of the device and the plurality of compute nodes prior to the synchronizing.

In Example 10, the subject matter of Example 9 can optionally include wherein a first compute node is identified based on information of a first data packet.

In Example 11, the subject matter of Example 9 can optionally include wherein the information includes a rank identification in a header of a first data packet.

Example 12 is a non-transitory machine-readable storage medium comprising information representative of instructions, wherein the instructions, when executed by processing circuitry, cause the processing circuitry to perform any operations of Examples 1-11.

Example 13 is a method for performing any operations of Examples 1-11.

Example 14 is a system comprising means for performing any operations of Examples 1-11.

Although these implementations have been described concerning specific exemplary aspects, it will be evident that various modifications and changes may be made to these aspects without departing from the broader scope of the present disclosure. Many of the arrangements and processes described herein can be used in combination or in parallel implementations that involve terrestrial network connectivity (where available) to increase network bandwidth/throughput and to support additional edge services. Accordingly, the specification and drawings are to be regarded in an illustrative rather than a restrictive sense. The accompanying drawings that form a part hereof show, by way of illustration, and not of limitation, specific aspects in which the subject matter may be practiced. The aspects illustrated are described in sufficient detail to enable those skilled in the art to practice the teachings disclosed herein. Other aspects may be utilized and derived therefrom, such that structural and logical substitutions and changes may be made without departing from the scope of this disclosure. This Detailed Description, therefore, is not to be taken in a limiting sense, and the scope of various aspects is defined only by the appended claims, along with the full range of equivalents to which such claims are entitled.

Such aspects of the inventive subject matter may be referred to herein, individually and/or collectively, merely for convenience and without intending to voluntarily limit the scope of this application to any single aspect or inventive concept if more than one is disclosed. Thus, although specific aspects have been illustrated and described herein, it should be appreciated that any arrangement calculated to achieve the same purpose may be substituted for the specific aspects shown. This disclosure is intended to cover any adaptations or variations of various aspects. Combinations of the above aspects and other aspects not specifically described herein will be apparent to those of skill in the art upon reviewing the above description.

What is claimed is:

1. A device comprising:
interfaces configured to receive data packets from a plurality of compute nodes; and
circuitry coupled to the interfaces, the circuitry to:
provide data to the plurality of compute nodes to synchronize reception of data packets received from the plurality of compute nodes, wherein the reception is synchronized to provide data of the data packets to each memory slot of a memory in an order.

2. The device of claim 1, wherein to synchronize data packet reception, the circuitry is configured to:
responsive to reception of a first data packet from a first compute node of the plurality of compute nodes, store the data of the first data packet in a first slot of the plurality of slots and transmit a pull command to a second compute node of the plurality of compute nodes to pull a data packet for storing in the first slot; and
store data of a second data packet from the first compute node in a second slot of the plurality of slots.

3. The device of claim 2, wherein:
the synchronizing further include operations to store the data from the second compute node in the first slot, subsequent to or concurrently an operation to store the second data from the first compute node in the second slot; and
subsequent to the synchronizing, the circuitry is configured to perform in-network computation based on data packets received from the plurality of compute nodes in an order provided during the synchronizing.

4. The device of claim 3, wherein to store the data from the second compute node in the first slot the circuitry is configured to combine the data from the second compute node with data of the first data packet from the first compute node into a single packet.

5. The device of claim 4, wherein the circuitry is configured to, upon detecting that data from each compute node has been stored into a slot, provide data packets stored in the respective slot to each of the compute nodes.

6. The device of claim 5, wherein the circuitry is configured to transmit pull commands, separately and iteratively, to additional compute nodes of the plurality of compute nodes, such that data received from the additional compute nodes are stored and combined with other data in sequential order in the first slot of the plurality of slots.

7. The device of claim 1, wherein the number of slots is at least the number of the plurality of computing nodes.

8. The device of claim 1, wherein a count of the plurality of slots is based on a configuration parameter provided to the device.

9. The device of claim 1, wherein an order for storing data packets of the plurality of slots is determined based upon configuration information received during a communication initialization process of the device and the plurality of compute nodes prior to the synchronizing.

10. The device of claim 9, wherein a first compute node is identified based on information of a first data packet.

11. The device of claim 9, wherein the information includes a rank identification in a header of a first data packet.

12. A non-transitory machine-readable storage medium comprising information representative of instructions, wherein the instructions, when executed by processing circuitry, cause the processing circuitry to:
receive data packets from a plurality of compute nodes;
configure a memory unit into a logical plurality of slots for storing the data packets; and
synchronize the plurality of compute nodes to provide data of the data packets to each memory slot of a memory in an order.

13. The non-transitory machine-readable storage medium of claim 12, wherein the synchronization includes:
responsive to receiving a first data packet from a first compute node of the plurality of compute nodes, storing the data packet in a first slot of the plurality of slots and transmitting a pull command to a second compute node of the plurality of compute nodes to pull a data packet for storing in the first slot;
receiving a second data packet from the first compute node and storing the second data packet in a second slot of the plurality of slots; and
storing the data packet from the second compute node in the first slot, subsequent to or concurrently with storing the second data packet from the first compute node in the second slot.

14. The non-transitory machine-readable storage medium of claim 13, wherein the instructions further include:
subsequent to the synchronizing, performing in-network computation based on data packets received from the plurality of compute nodes in an order provided during the synchronizing.

15. The non-transitory machine-readable storage medium of claim 14, wherein to store the data packet from the second compute node in the first slot the instructions includes combining the data packet from the second compute node with the first data packet from the first compute node into a single packet.

16. The non-transitory machine-readable storage medium of claim 14, wherein the instructions include upon detecting that data packets from each compute node has been stored into a slot, providing data packets stored in the respective slot to each of the compute nodes.

17. The non-transitory machine-readable storage medium of claim 16, wherein the instructions further cause the processing circuitry, in the synchronization, to generate pull commands separately and iteratively to additional compute nodes of the plurality of compute nodes, such that data packets of the additional compute nodes are stored and combined with other data packets in sequential order in the first slot of the plurality of slots.

18. The non-transitory machine-readable storage medium of claim 13, wherein an order for storing data packets of the plurality of slots is determined based upon configuration information received during a communication initialization process of a hardware switch with the plurality of compute nodes prior to the synchronizing.

19. A method for in-network computation, the method comprising:
receiving data packets from a plurality of compute nodes;
configuring a memory unit into a logical plurality of slots for storing the data packets; and
synchronizing the plurality of compute nodes to provide data of the data packets to each memory slot of a memory in an order.

20. The method of claim 19, wherein the synchronizing comprises:
responsive to receiving a first data packet from a first compute node of the plurality of compute nodes, storing the data packet in a first slot of the plurality of slots and transmitting a pull command to a second compute node of the plurality of compute nodes to pull a data packet for storing in the first slot;
receiving a second data packet from the first compute node and storing the second data packet in a second slot of the plurality of slots; and
storing the data packet from the second compute node in the first slot, subsequent to or concurrently with storing the second data packet from the first compute node in the second slot.
